(19) United States
(12) Patent Application Publication
(10) Pub. No.: US 2016/0238109 A1
(43) Pub. Date: Aug. 18, 2016

(54) DUAL-CLUTCH TRANSMISSION

(71) Applicant: ISUZU MOTORS LIMITED, Tokyo (JP)

(72) Inventor: Kouhei Akashi, Yokohama-shi (JP)

(73) Assignee: ISUZU MOTORS LIMITED, Tokyo (JP)

(21) Appl. No.: 15/030,172

(22) PCT Filed: Oct. 17, 2014
(86) PCT No.: PCT/JP2014/077695

§ 371 Date: Apr. 18, 2016

(30) Foreign Application Priority Data
Oct. 30, 2013 (JP) 2013-225221

(51) Int. Cl. F16H 3/091; F16H 3/00

(52) U.S. Cl. CPC F16H 3/0915; F16H 3/006

(57) ABSTRACT

A dual-clutch transmission includes: a first clutch; a first input shaft; a second clutch; a second input shaft; an output shaft; a countershaft; first and second input gear pairs; first, second, and third speed-change gear pairs; a first mechanism for coupling a first input primary gear of the first input gear pair or a second output primary gear to the output shaft; a second mechanism for coupling a second output counter gear of the second speed-change gear pair or a third output counter gear of the third speed-change gear pair to the counter shaft; and a third mechanism for coupling a first output primary gear of the first speed-change gear pair to the output shaft.

### TECHNICAL FIELD

The present invention relates to a dual-clutch transmission.

### BACKGROUND ART

To date, a dual-clutch transmission is known that includes a first input shaft provided with a first clutch that transmits or interrupts power from a driving source, a second input shaft provided with a second clutch that transmits or interrupts the power from the driving source, and a plurality of speed-change gear pairs (transmission gear pairs). Such a dual-clutch transmission shifts gears by switching between the first clutch and the second clutch in an alternating manner.

For example, PATENT LITERATURE DOCUMENT 1 discloses a dual-clutch transmission in which a primary gear pair is reused as a 6th-speed gear pair, and thus the number of gear pairs is reduced.

### LISTING OF REFERENCES

### Patent Literature Documents

PATENT LITERATURE DOCUMENT 1: Japanese Patent Application Laid-Open Publication (Kokai) No. 2010-531417

### SUMMARY OF THE INVENTION

### Problems to be Solved by the Invention

In the above-described conventional technique in which the primary gear pair is reused, as illustrated in FIG. 10(A), the gearshift between the 1st speed and the 2nd speed is achieved by connecting a 1st/2nd-speed shared gear pair 320 to an input shaft 140 and by selectively switching between a first primary gear pair 200 and a second primary gear pair 210. As illustrated in FIG. 10(B), the gearshift to the 5th speed is achieved by directly connecting a first input shaft 110 to the output shaft 140, and the gearshift to the 6th speed is achieved by reusing the first primary gear pair 200 as a gearshift gear pair.

In the conventional dual-clutch transmission, the gear ratio of the 1st speed to the 2nd speed equals the ratio of the gear ratio of the first primary gear pair 200 to the gear ratio of the second primary gear pair 210, and the gear ratio of the 5th speed to the 6th speed equals the inverse of the gear ratio of the second primary gear pair 210 to the gear ratio of the first primary gear pair 200. Thus, the gear ratio of the 1st speed to the 2nd speed is equal to the gear ratio of the 5th speed to the 6th speed.

In general, in order to ensure good feeling of connectedness at the time of shifting gears (hereinafter, referred to as “gearshift feeling”), it is preferred that a greater gear ratio be set to a ratio of one speed to a next speed in lower gears and a smaller gear ratio be set to a gear ratio of one speed to a next speed in higher gears. However, in the above-described dual-clutch transmission, the gear ratio of the 1st speed to the 2nd speed is equal to the gear ratio of the 5th speed to the 6th speed, and these gear ratios cannot be set independently to optimal values. Thus, there is a problem, i.e., the gearshift feeling deteriorates.

An object of the dual-clutch transmission disclosed herein is to effectively prevent the deterioration of the gearshift feeling.

### Solution to Overcome the Problems

A dual-clutch transmission disclosed herein includes a first input shaft provided with a first clutch that transmits or interrupts power from a driving source; a second input shaft provided with a second clutch that transmits or interrupts the power from the driving source; an output shaft disposed coaxially with the first input shaft; a countershaft disposed in parallel to the first input shaft, the second input shaft, and the output shaft; a first input gear pair including a first input primary gear fixed to the first input shaft, and a first input counter gear (auxiliary gear) that is provided on the countershaft and rotatable relative to the countershaft and that meshes with the first input primary gear; a second input gear pair including a second input primary gear fixed to the second input shaft, and a second input counter gear that is fixed to the countershaft and that meshes with the second input primary gear; a first speed-change gear pair including a first output primary gear provided on the output shaft and rotatable relative to the output shaft, and a first output counter gear that is fixed to the countershaft and that meshes with the first output primary gear; a second speed-change gear pair including a second output primary gear provided on the output shaft and rotatable relative to the output shaft, the second output primary gear being closer to an input end than the first output primary gear is, and a second output counter gear that is configured to be integrally rotatable with the first input counter gear and that meshes with the second output primary gear; a third speed-change gear pair including a third output primary gear fixed to the output shaft at a position between the second output primary gear and the first output primary gear, and a third output counter gear that is provided on the countershaft and rotatable relative to the countershaft and that meshes with the third output primary gear; a first connecting unit capable of selectively connecting the first input primary gear or the second output primary gear to the output shaft; a second connecting unit capable of selectively connecting the second output counter gear or the third output counter gear to the countershaft; and a third connecting unit capable of selectively connecting at least the first output primary gear to the output shaft.

### Advantages of the Invention

The dual-clutch transmission disclosed herein can effectively prevent the deterioration of the gearshift feeling.

### BRIEF DESCRIPTION OF THE DRAWINGS

FIG. 1 is a skeleton diagram of a dual-clutch transmission according to an embodiment of the present invention.

FIG. 2 illustrates a 1st-speed power transmitting path in the dual-clutch transmission illustrated in FIG. 1.

FIG. 3 illustrates a 2nd-speed power transmitting path in the dual-clutch transmission illustrated in FIG. 1.

FIG. 4 illustrates a 3rd-speed power transmitting path in the dual-clutch transmission illustrated in FIG. 1.

FIG. 5 illustrates a 4th-speed power transmitting path in the dual-clutch transmission illustrated in FIG. 1.

FIG. 6 illustrates a 5th-speed power transmitting path in the dual-clutch transmission illustrated in FIG. 1.

FIG. 7 illustrates a 6th-speed power transmitting path in the dual-clutch transmission illustrated in FIG. 1.

FIG. 8 illustrates a 7th-speed power transmitting path in the dual-clutch transmission illustrated in FIG. 1.

FIG. 9 is a graph useful to describe an example of a step ratio (ratio of one speed gear ratio to another speed gear ratio) in the embodiment of the present invention.

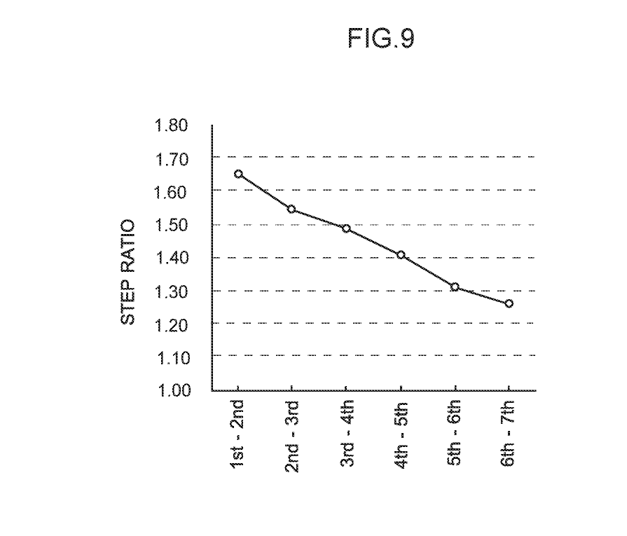

FIG. 10 is a set of views useful to describe power transmitting paths in a conventional dual-clutch transmission.

### Mode for Carrying out the Invention

Hereinafter, a dual-clutch transmission according to an embodiment of the present invention will be described with reference to the accompanying drawings. Identical components are given identical reference characters, and their names and functions are identical as well. Therefore, detailed descriptions of such components will not be repeated.

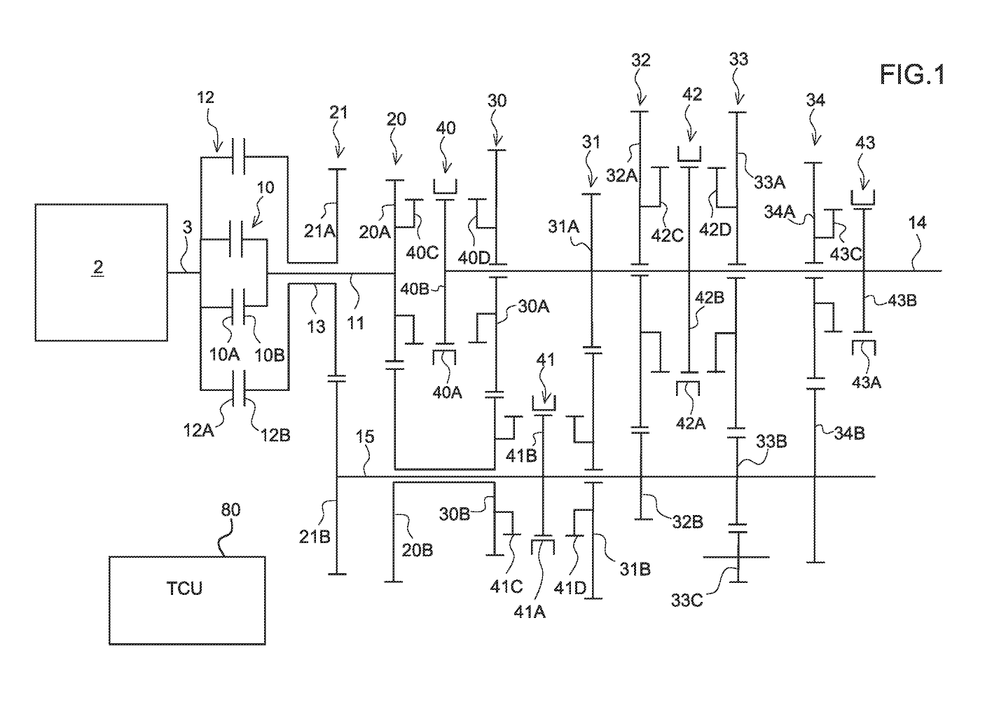

As illustrated in FIG. 1, a first clutch 10 is provided at an input end of a first input shaft 11. A second clutch 12 is provided at an input end of a second input shaft 13. The second input shaft 13 has a hollow shaft that penetrates in the axial direction, and the first input shaft extends through this hollow shaft such that the first input shaft is rotatable relative to the hollow shaft.

An output shaft 14 is disposed coaxially with the first input shaft 11, and is spaced from the first input shaft 11. A countershaft 15 is disposed in parallel with the input shafts 11 and 13 and the output shaft 14.

The first clutch 10 includes a first pressure plate 10A fixed to a crankshaft 3 of an engine 2 and a first clutch disc 10B fixed to the input end of the first input shaft 11. As the first pressure plate 10A moves to make pressure-contact with the first clutch disc 10B, the power of the engine 2 is transmitted to the first input shaft 11 via the first clutch 10.

The second clutch 12 includes a second pressure plate 12A fixed to the crankshaft 3 of the engine 2 and a second clutch disc 12B fixed to the input end of the second input shaft 13. As the second pressure plate 12A moves to make pressure-contact with the second clutch disc 12B, the power of the engine 2 is transmitted to the second input shaft 13 via the second clutch 12.

A first primary gear pair 20, which is an example of a first input gear pair according to the present invention, includes a first input gear 20A and a first counter gear (auxiliary gear) 20B. The first input gear 20A meshes with the first counter gear 20B. The first input gear 20A is fixed to an output end of the first input shaft 11. The first counter gear 20B is provided on the countershaft 15 such that the first counter gear 20B is rotatable relative to the countershaft 15. The first counter gear 20B is integrated with a 3rd-speed counter gear 30B, which will be described later.

A second primary gear pair 21, which is an example of a second input gear pair according to the present invention, includes a second input gear 21A and a second counter gear 21B. The second input gear 21A meshes with the second counter gear 21B. The second input gear 21A is fixed to an output end of the second input shaft 13. The second counter gear 21B is fixed to an input end of the countershaft 15. The power of the engine 2 transmitted to the second input shaft 13 via the second clutch 12 is directly transmitted to the countershaft 15 via the second primary gear pair 21.

A 3rd-speed gear pair 30, which is an example of a second speed-change gear pair according to the present invention, includes a 3rd-speed output gear 30A and the 3rd-speed counter gear 30B. The 3rd-speed output gear 30A meshes with the 3rd-speed counter gear 30B. The 3rd-speed output gear 30A is provided on the output shaft 14 such that the 3rd-speed output gear 30A is rotatable relative to the output shaft 14. The 3rd-speed counter gear 30B is formed so as to be integrally rotatable with the first counter gear 20B. Specifically, a hollow shaft is formed in the first counter gear 20B and the 3rd-speed counter gear 30B, which are integrated, so as to penetrate therethrough in the axial direction. The countershaft 15 extends through the hollow shaft such that the countershaft 15 is freely rotatable. The number of teeth in the 3rd-speed output gear 30A is greater than the number of teeth in the 3rd-speed counter gear 30B.

A 6th-speed gear pair 31, which is an example of a third speed-change gear pair according to the present invention, includes a 6th-speed output gear 31A and a 6th-speed counter gear 31B. The 6th-speed output gear 31A meshes with the 6th-speed counter gear 31B. The 6th-speed output gear 31A is fixed to the output shaft 14, and the 6th-speed counter gear 31B is provided on the countershaft 15 such that 6th-speed counter gear 31B is rotatable relative to the countershaft 15. The number of teeth in the 6th-speed output gear 31A is smaller than the number of teeth in the 6th-speed counter gear 31B.

A 1st/2nd-speed shared gear pair 32, which is an example of a first speed-change gear pair according to the present invention, includes a 1st/2nd-speed output gear 32A and a 1st/2nd-speed counter gear 32B. The 1st/2nd-speed output gear 32A meshes with the 1st/2nd-speed counter gear 32B. The 1st/2nd-speed output gear 32A is provided on the output shaft 14 such that the 1st/2nd-speed output gear 32A is rotatable relative to the output shaft 14, and the 1st/2nd-speed counter gear 32B is fixed to the countershaft 15. The number of teeth in the 1st/2nd-speed output gear 32A is greater than the number of teeth in the 1st/2nd-speed counter gear 32B.

A reverse gear set 33 includes a reverse output gear 33A, a reverse counter gear 33B, and an idler gear 33C, which mesh with one another. The reverse output gear 33A is provided on the output shaft 14 such that the reverse output gear 33A is rotatable relative to the output shaft 14, and the reverse counter gear 33B is fixed to the countershaft 15.

A 4th-speed gear pair 34, which is an example of a fourth speed-change gear pair according to the present invention, includes a 4th-speed output gear 34A and a 4th-speed counter gear 34B. The 4th-speed output gear 34A meshes with the 4th-speed counter gear 34B. The 4th-speed output gear 34A is provided on the output shaft 14 such that the 4th-speed output gear 34A is rotatable relative to the output shaft 14, and the 4th-speed counter gear 34B is fixed to the countershaft 15. The number of teeth in the 4th-speed output gear 34A is greater than the number of teeth in the 4th-speed counter gear 34B.

A first synchronizer mechanism 40, which is an example of a first connecting unit according to the present invention, includes a first sleeve 40A movable in the axial direction in accordance with a shift operation of a shift lever device (not illustrated), a spline 40B fixed to an input end of the output shaft 14, a spline 40C fixed to the first input gear 20A, and a spline 40D fixed to the 3rd-speed output gear 30A.

As the first sleeve 40A moves toward the first input gear 20A and engages with the spline 40C, the first input gear 20A is connected to the output shaft 14 (the first input shaft 11 is directly connected to the output shaft 14). On the other hand, as the first sleeve 40A moves toward the 3rd-speed output gear 30A and engages with the spline 40D, the 3rd-speed output gear 30A is connected to the output shaft 14. In other words, the first synchronizer mechanism 40 can selectively connect the first input gear 20A or the 3rd-speed output gear 30A to the output shaft 14.

A second synchronizer mechanism 41, which is an example of a second connecting unit according to the present invention, includes a second sleeve 41A movable in the axial direction, a spline 41B fixed to the countershaft 15 at a position between the 3rd-speed counter gear 30B and the 6th-speed counter gear 31B, a spline 41C fixed to the 3rd-speed counter gear 30B, and a spline 41D fixed to the 6th-speed counter gear 31B.

As the second sleeve 41A moves toward the 3rd-speed counter gear 30B and engages with the spline 41C, the 3rd-speed counter gear 30B becomes connected to the countershaft 15. On the other hand, as the second sleeve 41A moves toward the 6th-speed counter gear 31B and engages with the spline 42D, the 6th-speed counter gear 31B becomes connected to the countershaft 15. In other words, the second synchronizer mechanism 41 can selectively connect the 3rd-speed counter gear 30B or the 6th-speed counter gear 31B to the countershaft 15.

A third synchronizer mechanism 42, which is an example of a third connecting unit according to the present invention, includes a third sleeve 42A movable in the axial direction, a spline 42B fixed to the output shaft 14 at a position between the 1st/2nd-speed output gear 32A and the reverse output gear 33A, a spline 42C fixed to the 1st/2nd-speed output gear 32A, and a spline 42D fixed to the reverse output gear 33A.

As the third sleeve 42A moves toward the 1st/2nd-speed output gear 32A and engages with the spline 42C, the 1st/2nd-speed output gear 32A becomes connected to the output shaft 14. On the other hand, as the third sleeve 42A moves toward the reverse output gear 33A and engages with the spline 42D, the reverse output gear 33A becomes connected to the output shaft 14. In other words, the third synchronizer mechanism 42 can selectively connect the 1st/2nd-speed output gear 32A or the reverse output gear 33A to the output shaft 14.

A fourth synchronizer mechanism 43, which is an example of a fourth connecting unit according to the present invention, includes a fourth sleeve 43A movable in the axial direction, a spline 43B fixed to the output shaft 14 at a position where the spline 43B is closer to the output end than the 4th-speed output gear 34A is, and a spline 43C fixed to the 4th-speed output gear 34A.

As the fourth sleeve 43A moves toward the 4th-speed output gear 34A and engages with the spline 43C, the 4th-speed output gear 34A becomes connected to the output shaft 14. In other words, the fourth synchronizer mechanism 43 can selectively connect the 4th-speed output gear 34A to the output shaft 14.

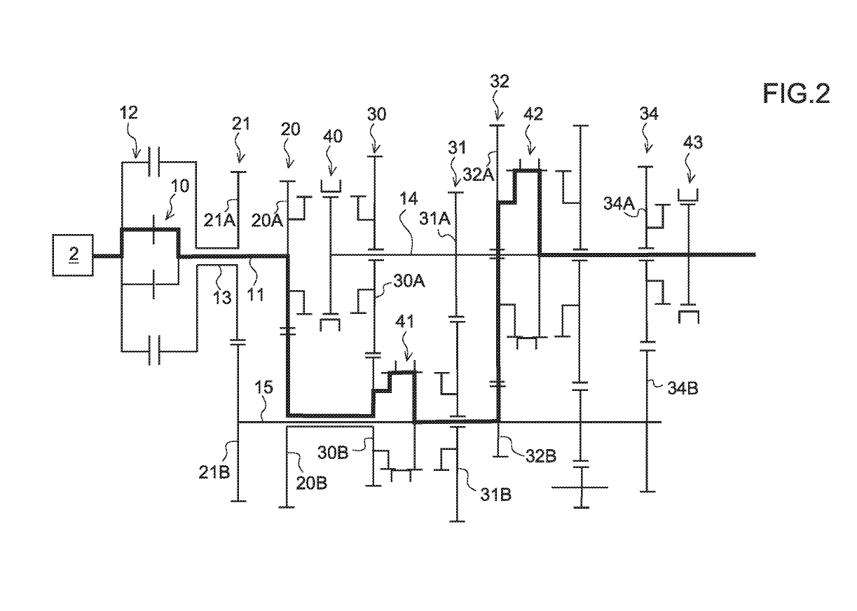

A transmission control unit (TCU) 80 executes gear-shifting control to actuate the first clutch 10, the second clutch 12, and the synchronizer mechanisms 40 to 43 in accordance with a shift operation of a shift device (not illustrated). In the following description, the power transmitting paths in the forward-moving positions in the gear-shifting control of the TCU 80 will be described with reference to FIGS. 2 to 8.

FIG. 2 illustrates a 1st-speed power transmitting path. In the 1st speed, the first clutch 10 is selected, the second synchronizer mechanism 41 connects the 3rd-speed counter gear 30B to the countershaft 15, and the third synchronizer mechanism 42 connects the 1st/2nd-speed output gear 32A to the output shaft 14.

In other words, the power of the engine 2 is transmitted to the output shaft 14 via the first clutch 10, the first input shaft 11, the first primary gear pair 20, the 3rd-speed counter gear 30B, the countershaft 15, and the 1st/2nd-speed shared gear pair 32.

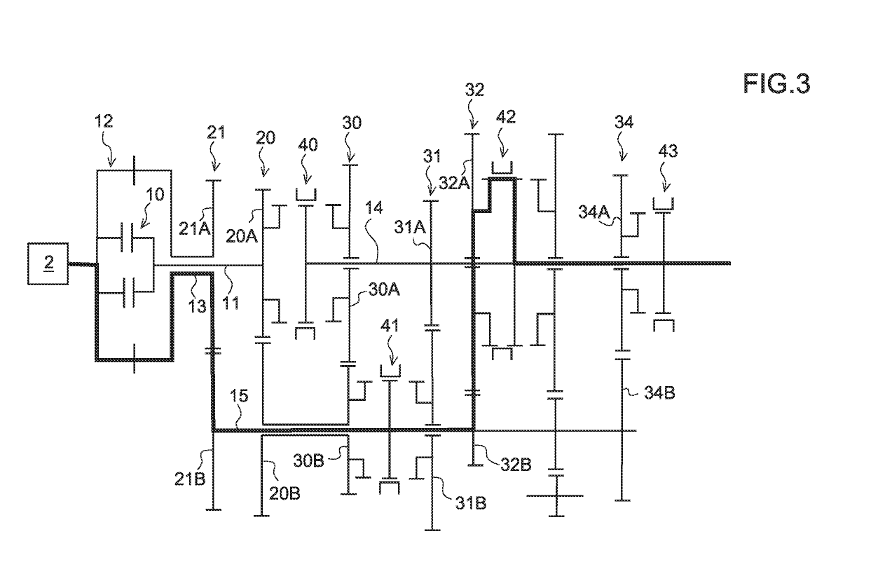

FIG. 3 illustrates a 2nd-speed power transmitting path. The 2nd speed is achieved by switching, from the state of the 1st-speed, the first clutch 10 to the second clutch 12. In other words, the power of the engine 2 is transmitted to the output shaft 14 via the second clutch 12, the second input shaft 13, the second primary gear pair 21, the countershaft 15, and the 1st/2nd-speed shared gear pair 32.

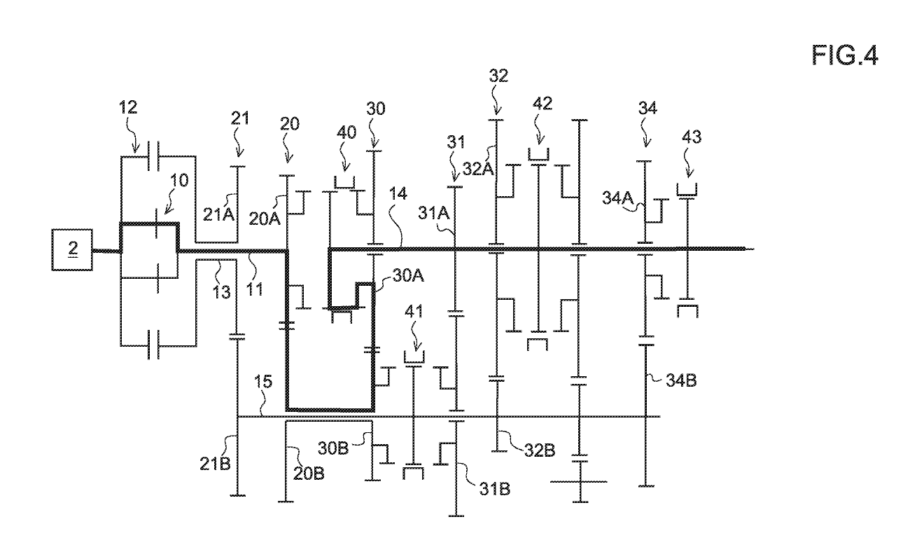

FIG. 4 illustrates a 3rd-speed power transmitting path. To achieve the 3rd speed, the first synchronizer mechanism 40 connects the 3rd-speed output gear 30A to the output shaft 14 in the state of the 2nd speed, and a standby state is entered. Then, the second clutch 12 is switched to the first clutch 10.

In other words, the power of the engine 2 is transmitted to the output shaft 14 via the first clutch 10, the first input shaft 11, the first primary gear pair 20, and the 3rd-speed gear pair 30.

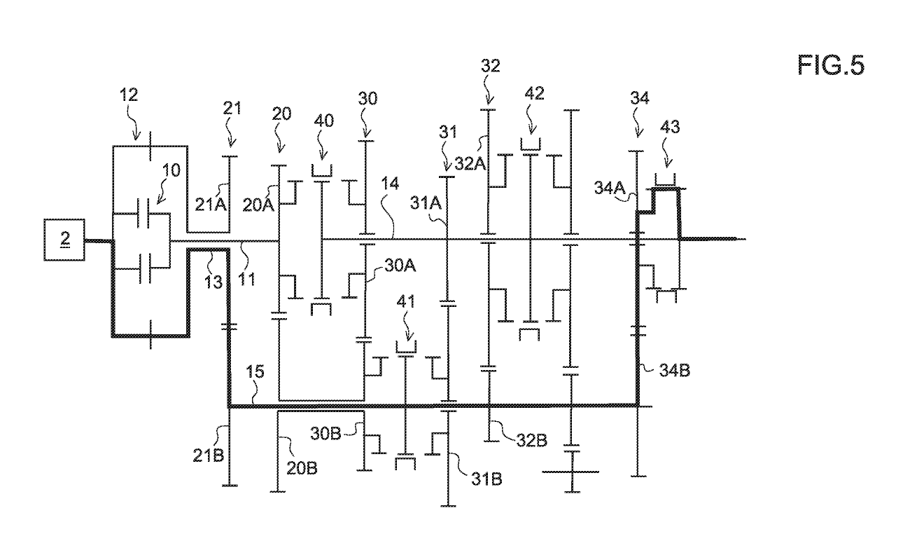

FIG. 5 illustrates a 4th-speed power transmitting path. To achieve the 4th speed, the fourth synchronizer mechanism 43 connects the 4th-speed output gear 34A to the output shaft 14 in the state of the 3rd speed, and a standby state is entered. Then, the first clutch 10 is switched to the second clutch 12.

In other words, the power of the engine 2 is transmitted to the output shaft 14 via the second clutch 12, the second input shaft 13, the second primary gear pair 21, the countershaft 15, and the 4th-speed gear pair 34.

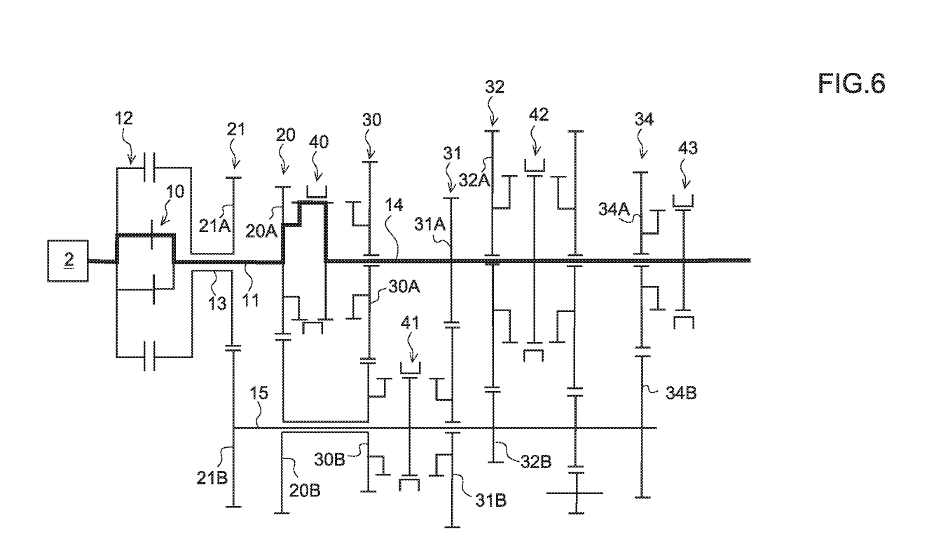

FIG. 6 illustrates a 5th-speed power transmitting path. To achieve the 5th speed, the first synchronizer mechanism 40 (directly) connects the first input gear 20A to the output shaft 14 in the state of the 4th speed, and a standby state is entered. Then, the second clutch 12 is switched to the first clutch 10.

In other words, the power of the engine 2 is transmitted to the output shaft 14 via the first clutch 10, the first input shaft 11, and the first input gear 20A.

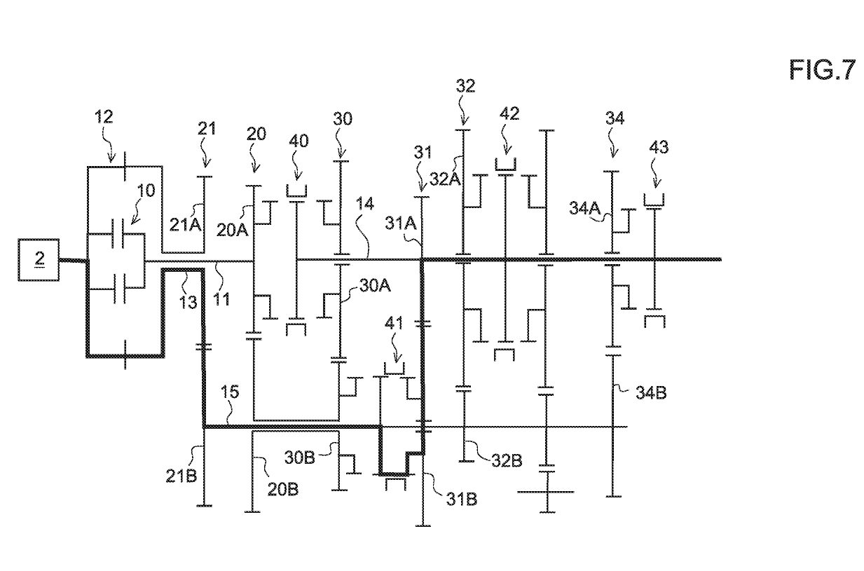

FIG. 7 illustrates a 6th-speed power transmitting path. To achieve the 6th speed, the second synchronizer mechanism 41 connects the 6th-speed counter gear 31B to the countershaft 15 in the state of the 5th speed, and a standby state is entered. Then, the first clutch 10 is switched to the second clutch 12.

In other words, the power of the engine 2 is transmitted to the output shaft 14 via the second clutch 12, the second input shaft 13, the second primary gear pair 21, the countershaft 15, and the 6th-speed gear pair 31.

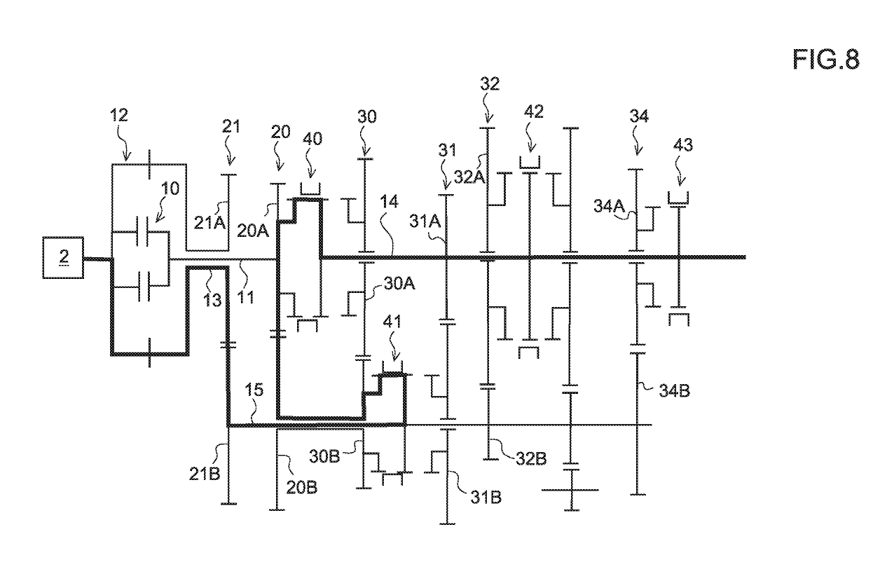

FIG. 8 illustrates a 7th-speed power transmitting path. To achieve the 7th speed, the second clutch 12 is temporarily disconnected in the state of the 6th speed. Then, the first synchronizer mechanism 40 connects the first input gear 20A to the output shaft 14, the second synchronizer mechanism 41 connects the 3rd-speed counter gear 30B to the countershaft 15, and the second clutch 12 is reconnected.

In other words, the power of the engine 10 is transmitted to the output shaft 14 via the second clutch 12, the second input shaft 13, the second primary gear pair 21, the countershaft 15, the 3rd-speed counter gear 30B, and the first primary gear pair 20. Thus, the first primary gear pair 20 can be reused as a speed-change gear pair (transmission gear pair). It should be noted that when shifting from the 6th speed to the 7th speed, the second clutch 12 is disconnected and connected, and thus a so-called torque loss occurs. However, its influence is small in the high-order speeds.

The gear ratios and the step ratios in the dual-clutch transmission according to the present embodiment will now be described. The numerical values used in the following description are merely examples of the present embodiment, and any optimal values can be set as appropriate within the scope that does not depart from the spirit of the present invention.

Examples of the number of teeth and the gear ratio in each gear pair are shown in Table 1, and the gear ratios in the gear positions 1 to 7 (1st speed to 7th speed) are shown in Table 2. In Table 1, the number of teeth Z1 in the upper row indicates the number of teeth in a gear provided on the countershaft 15, and the number of teeth Z2 in the middle row indicates the number of teeth in a gear provided on the input shaft 11 or 13 or the output shaft 14.

TABLE 1

| | Pri-1 | Pri-2 | 3rd | 6^{th} | 1st/2nd | 4th |
|---|---|---|---|---|---|---|
| Number of | 28 | 40 | 30 | 37 | 13 | 27 |
| teeth Z1 | | | | | | |
| Number of | 45 | 39 | 39 | 29 | 43 | 39 |
| teeth Z2 | | | | | | |
| Gear ratio | 1.61 | 0.98 | 1.30 | 0.78 | 3.31 | 1.44 |

TABLE 2

| | 1st | 2nd | 3rd | 4th | 5th | 6th | 7th |
|---|---|---|---|---|---|---|---|
| Primary gear | 1.61 | 0.98 | 1.61 | 0.98 | 1.00 | 0.98 | 0.98 |
| ratio | | | | | | | |
| Speed-change | 3.31 | 3.31 | 1.30 | 1.44 | 1.00 | 0.78 | 0.62 |
| gear ratio | | | | | | | |
| Total gear ratio | 5.316 | 3.225 | 2.089 | 1.408 | 1.000 | 0.764 | 0.607 |

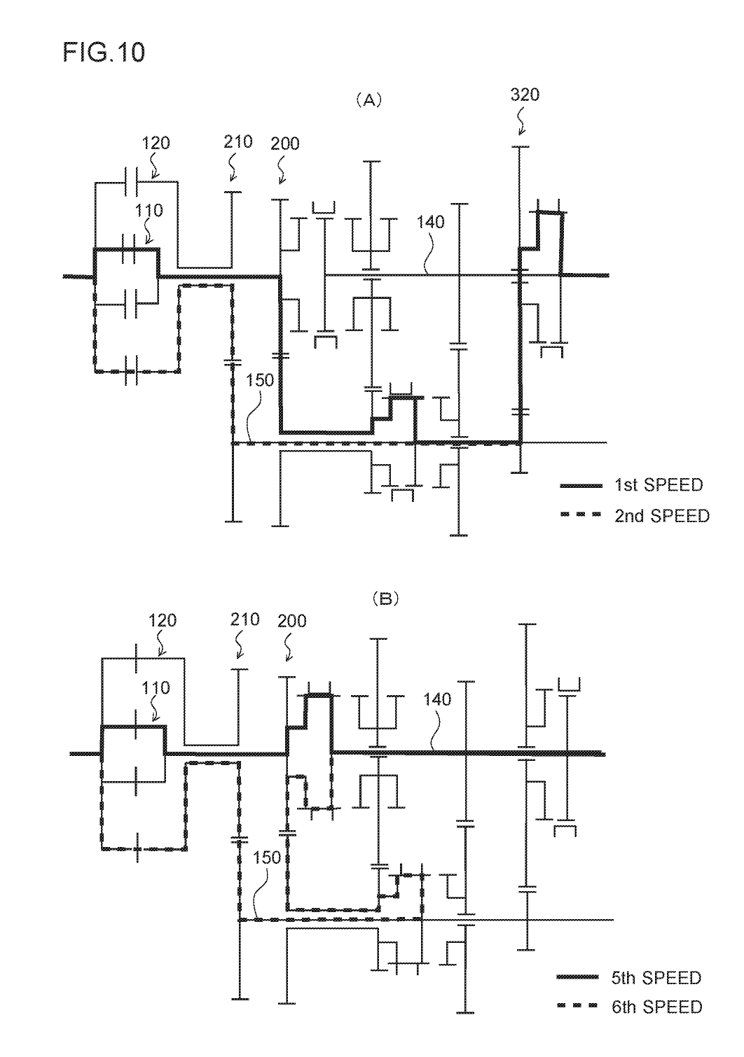

The step ratio of the 1st speed to the 2nd speed, and the step ratio of the 5th speed to the 7th speed are calculated from Table 2. The step ratio of the 1st speed to the 2nd speed is approximately 1.648 (=1st speed/2nd speed), and the step ratio of the 5th speed to the 7th speed is also approximately 1.648 (=5th speed/7th speed). These step ratios are substantially equal to each other. In order to retain favorable gearshift feeling, it is preferred that a greater step ratio be set in lower gears (lower speeds) and a smaller step ratio be set in higher gears (higher speeds). In the present embodiment, even when the step ratio of the 1st speed to the 2nd speed is extended and the step ratio of the 5th speed to the 7th speed is correspondingly extended, a small step ratio can be set in high gears, as illustrated in FIG. 10 for example, since the 6th-speed gear pair 31 of which the gear ratio can be set independently is provided.

In addition, the output gears of the 3rd-speed gear pair 30, the 1st/2nd-speed shared gear pair 32, and the 4th-speed gear pair 34, which are reduction gear pairs, are all supported on the output shaft 14 so as to be idle, and only the output gear 31A of the 6th-speed gear pair 31, which is an acceleration gear pair, is fixed to the output shaft 14. Therefore, there is no counter gear that is continuously accelerated relative to the output shaft 14, and heat production, wears, and so on to be caused by high-speed rotations are effectively suppressed.

Advantageous effects of the dual-clutch transmission according to the present embodiment will now be described.

In a conventional dual-clutch transmission, the step ratio of the 1st speed to 2nd speed is equal to the step ratio of the 5th speed to 6th speed, and these step ratios cannot be set independently to optimal values. Thus, an issue remains in that the gearshift feeling deteriorates.

On the contrary, in the dual-clutch transmission according to the present embodiment, although the step ratio of the 1st speed to the 2nd speed is equal to the step ratio of the 5th speed to the 7th speed, the 6th-speed gear pair 31 of which the gear ratio can be set independently is provided between the 5th speed and the 7th speed. In other words, even when the step ratio of the 1st speed to the 2nd speed is extended to improve the gearshift feeling and the step ratio of the 5th speed to the 7th speed is correspondingly extended, the step ratio in higher gears can be set small because the 6th-speed gear pair 31 is provided between the 5th speed and the 7th speed. Accordingly, the dual-clutch transmission of this embodiment can set favorable step ratios that are smaller in higher gears and to effectively improve the gearshift feeling.

In addition, a conventional dual-clutch transmission suffers from another problem. An output gear of a reduction gear pair (e.g., 4th-speed gear pair) is fixed to an output shaft. Therefore, high-speed rotations of the output shaft cause the counter gear to rotate at even higher speed than the output shaft. This increases heat generation, wears, losses, and so on.

On the contrary, in the dual-clutch transmission according to this embodiment, only the 6th-speed output gear 31A is fixed to the output shaft 14, and the other output gears are supported on the output shaft 14 so as to be idle. The 6th-speed gear pair 31 is an acceleration gear pair, and thus the rotations of the output shaft 14 are continuously decelerated and transmitted to the 6th-speed counter gear 31B. Accordingly, the dual-clutch transmission of this embodiment can effectively reduce heat generation, wears, losses, and so on in the counter gears, since there is no counter gear that is continuously accelerated relative to the output shaft 14.

It should be noted that the present invention is not limited to the above-described embodiments and can be implemented with appropriate changes and modifications within the scope that does not depart from the spirit of the present invention.

For example, the 3rd-speed counter gear 30B and the first counter gear 20B do not have to be integrated and may be provided as separate gears. In this configuration, the 3rd-speed counter gear 30B and the first counter gear 20B may be configured to be selectively connectable to the countershaft 15 with a synchronizer mechanism or the like.

### REFERENCE NUMERALS AND SYMBOLS

2: Engine

10: First clutch

11: First input shaft

12: Second clutch

13: Second input shaft

14: Output shaft

15: Countershaft

20: First primary gear pair

21: Second primary gear pair

30: 3rd-speed gear pair

31: 6th-speed gear pair

32: 1st/2nd-speed shared gear pair

34: 4th-speed gear pair

40: First synchronizer mechanism

41: Second synchronizer mechanism

42: Third synchronizer mechanism

43: Fourth synchronizer mechanism

1. A dual-clutch transmission comprising:
a first input shaft provided with a first clutch that transmits or interrupts power from a driving source;
a second input shaft provided with a second clutch that transmits or interrupts the power from the driving source;
an output shaft disposed coaxially with the first input shaft;
a countershaft disposed in parallel with the first input shaft, the second input shaft, and the output shaft;
a first input gear pair including a first input primary gear fixed to the first input shaft, and a first input counter gear provided on the countershaft such that the first input counter gear is rotatable relative to the countershaft, the first input counter gear being configured to mesh with the first input primary gear;
a second input gear pair including a second input primary gear fixed to the second input shaft, and a second input counter gear fixed to the countershaft, the second input counter gear being configured to mesh with the second input primary gear;
a first speed-change gear pair including a first output primary gear provided on the output shaft such that the first output primary gear is rotatable relative to the output shaft, and a first output counter gear fixed to the countershaft, the first output counter gear being configured to mesh with the first output primary gear;
a second speed-change gear pair including a second output primary gear provided on the output shaft such that the second output primary gear is rotatable relative to the output shaft, the second output primary gear being closer to an input end of the output shaft than the first output primary gear, and a second output counter gear configured to be integrally rotatable with the first input counter gear, the second output counter gear being configured to mesh with the second output primary gear;
a third speed-change gear pair including a third output primary gear fixed to the output shaft at a position between the second output primary gear and the first output primary gear, and a third output counter gear provided on the countershaft such that the third output counter gear is rotatable relative to the countershaft, the third output counter gear being configured to mesh with the third output primary gear;
a first connecting mechanism configured to selectively connect the first input primary gear or the second output primary gear to the output shaft;
a second connecting mechanism configured to selectively connect the second output counter gear or the third output counter gear to the countershaft; and
a third connecting mechanism configured to selectively connect at least the first output primary gear to the output shaft.

2. The dual-clutch transmission according to claim 1 further comprising:
a fourth speed-change gear pair including a fourth output primary gear provided on the output shaft such that the fourth output primary gear is rotatable relative to the output shaft, the fourth output primary gear being closer to an output end of the output shaft than the first output primary gear, and a fourth output counter gear fixed to the countershaft, the fourth output counter gear being configured to mesh with the fourth output primary gear; and
a fourth connecting mechanism configured to selectively connect at least the fourth output counter gear to the countershaft.

3. The dual-clutch transmission according to claim 2, wherein the first, second, and fourth speed-change gear pairs are reduction gear pairs of which the numbers of teeth in the gears on the output shaft are greater than the numbers of teeth in the gears on the countershaft, and
the third speed-change gear pair is an acceleration gear pair of which the number of teeth in the gear on the output shaft is smaller than the number of teeth in the gear on the countershaft.

4. The dual-clutch transmission according to claim 1, wherein the first speed-change gear pair is a gear pair shared for 1st speed and 2nd speed, the third speed-change gear pair is a gear for 6th speed, and
for 7th-speed, the second clutch is connected, the second connecting mechanism connects the second output counter gear to the countershaft, the first connecting mechanism connects the first input primary gear to the output shaft, and the first input gear pair is used as a speed-change gear pair.

5. The dual-clutch transmission according to claim 2, wherein the first speed-change gear pair is a gear pair shared for 1st speed and 2nd speed, the third speed-change gear pair is a gear for 6th speed, and
for 7th-speed, the second clutch is connected, the second connecting mechanism connects the second output counter gear to the countershaft, the first connecting mechanism connects the first input primary gear to the output shaft, and the first input gear pair is used as a speed-change gear pair.

6. The dual-clutch transmission according to claim 3, wherein the first speed-change gear pair is a gear pair shared for 1st speed and 2nd speed, the third speed-change gear pair is a gear for 6th speed, and
for 7th-speed, the second clutch is connected, the second connecting mechanism connects the second output counter gear to the countershaft, the first connecting mechanism connects the first input primary gear to the output shaft, and the first input gear pair is used as a speed-change gear pair.

7. The dual-clutch transmission according to claim 1, wherein the first input counter gear is integral with the second output counter gear.

8. The dual-clutch transmission according to claim 1, wherein the first input counter gear is a separate gear from the second output counter gear.
